(19) United States
(12) Patent Application Publication
(10) Pub. No.: US 2025/0384660 A1
(43) Pub. Date: Dec. 18, 2025

(54) FOUNDATION MODELS FOR MULTIMODAL SEMANTIC DATA SELECTION AND DATASET ENRICHMENT

(71) Applicant: NVIDIA Corporation, Santa Clara, CA (US)

(72) Inventors: Maying SHEN, Fremont, CA (US); Nai Chen CHANG, Hillsborough, CA (US); Jose Manuel ALVAREZ LOPEZ, Mountain View, CA (US); Sifei LIU, San Diego, CA (US)

(73) Assignee: NVIDIA Corporation, Santa Clara, CA (US)

(21) Appl. No.: 19/041,709

(22) Filed: Jan. 30, 2025

Related U.S. Application Data
(60) Provisional application No. 63/660,576, filed on Jun. 17, 2024.

(51) Int. Cl. G06V 10/762; G06V 10/82; G06V 20/70

(52) U.S. Cl. CPC G06V 10/762; G06V 10/82; G06V 20/70

(57) ABSTRACT

In various examples, a system can perform multimodal selection of data to generate and/or enrich efficient datasets. The system can retrieve clusters of image frames generated according to semantic characteristics, such as semantic embeddings, of the image frames. The system can selectively filter out image frames from the clusters that are visually similar to other image frames in the clusters, which can reduce the size of the resulting dataset while maintaining target amounts of semantic information in the dataset. The system can selectively add new image frames to the dataset, such as new image frames that have semantic differences from the images of the dataset. The system can update any of various AI models, such as to fine-tune a neural network-based model, suing the dataset.

### CROSS-REFERENCE TO RELATED APPLICATIONS

This application claims the benefit of U.S. Provisional Application No. 63/660,576, filed on Jun. 17, 2024, the contents of which are hereby incorporated by reference in their entirety.

### BACKGROUND

Artificial intelligence (AI) models, including foundational models, are trained using large datasets. In these datasets, data samples are often labeled with information relating to what is represented in the data samples, such as classes of objects or other features represented in the data samples. However, performance increases of many AI models have tapered given the large size of available datasets; as additional data is identified, significant resources are required to label and/or effectively incorporate such data. For many AI models, the amount of compute required to train on increasing amounts of data can involve significant resources without necessarily achieving expected improvements in model performance.

### SUMMARY

Implementations of the present disclosure relate to multimodal semantic data selection and/or enrichment using machine learning models. Systems and methods are disclosed that can generate efficient datasets to facilitate improvement of AI models trained using such datasets, such as to achieve or exceed target performance criteria with reduced sized datasets.

In contrast to conventional systems, such as those described above, systems and methods in accordance with the present disclosure can selectively generate datasets that meet both performance and resource usage criteria, such as by using semantic and/or visual evaluation of images to effectively filter for more useful images. This can allow for reduced compute resources required for training, reduced data storage and/or network communication requirements for datasets, and/or increased performance of resulting models.

At least one aspect relates to one or more processors. The one or more processors can include processing circuitry to generate, using one or more neural networks, (i) a semantic embedding of one or more image frames of the plurality of image frames and (ii) a visual embedding of each of the one or more image frames of the plurality of image frames; generate a plurality of clusters of the plurality of image frames according to the semantic embedding of each of the one or more image frames of the plurality of frames; and remove, from at least one cluster of the plurality of clusters, at least one image frame according to the visual embedding of the at least one image frame and at least one other image frame of the cluster to provide a dataset comprising the plurality of image frames remaining from the plurality of clusters.

In some implementations, the plurality of image frames are a plurality of first image frames. The processing circuitry can cause the one or more neural networks to generate a semantic embedding of at least one second image frame, can identify a given cluster of the plurality of clusters corresponding to the semantic embedding, and can add the at least one second image frame to the dataset responsive to the semantic embedding of the at least one second image frame satisfying one or more difference thresholds with respect to the given cluster.

In some implementations, the one or more neural networks can include a multimodal language model (MLMM) to generate a description of each of the one or more image frames, a transformer to generate the semantic embedding of each of the one or more image frames according to the description of each respective image frame, and a vision encoder configured to generate the visual embedding according to each image frame. In some implementations, the plurality of image frames include driving environment images.

In some implementations, the processing circuitry is to evaluate a performance of an objection detection model that is trained according to the dataset relative to being trained/updated according to the plurality of image frames. In some implementations, the processing circuitry is to remove the at least one image frame based at least on a similarity score between the visual embedding of the at least one image frame and the visual embedding of the at least one other image frame.

At least one aspect relates to a system that includes one or more processors. The one or more processors can generate, using one or more neural networks, (i) a semantic embedding of one or more image frames of the plurality of image frames, and (ii) a visual embedding of each of the one or more image frames of the plurality of image frames; can generate a plurality of clusters of the plurality of image frames according to the semantic embedding of each of the one or more image frames of the plurality of frames; and can remove, from at least one cluster of the plurality of clusters, at least one image frame according to the visual embedding of the at least one image frame and at least one other image frame of the cluster to provide a dataset comprising the plurality of image frames remaining from the plurality of clusters.

In some implementations, the plurality of image frames are a plurality of first image frames. The one or more processors can cause the one or more neural networks to generate a semantic embedding of at least one second image frame, can identify a given cluster of the plurality of clusters corresponding to the semantic embedding, and can add the at least one second image frame to the dataset responsive to the semantic embedding of the at least one second image frame satisfying one or more difference thresholds with respect to the given cluster.

In some implementations, the one or more neural networks include a multimodal language model (MLMM) to generate a description of each image frame, a transformer to generate the semantic embedding of each image frame according to the description of each image frame, and a vision encoder configured to generate the visual embedding according to each image frame.

In some implementations, the plurality of image frames include driving environment images. In some implementations, the one or more processors are to evaluate a performance of an objection detection model that is updated/trained according to the dataset relative to being/trained (which can include, for example and without limitation, being updated, retrained, fine-tuned, conditioned, etc.) according to the plurality of image frames. In some implementations, the one or more processors are to remove the at least one image frame based at least on a similarity score between the visual embedding of the at least one image frame and the visual embedding of the at least one other image frame.

At least one aspect relates to a method. The method can include generating, based at least on a semantic characteristic of one or more image frames of a plurality of image frames, a plurality of clusters to which a respective subset of the plurality of image frames is assigned. The method can include filtering the respective subset of at least one cluster of the plurality of clusters by removing at least one image frame of the respective subset based at least on a visual characteristic of the at least one image frame that indicates that the at least one image frame has a threshold amount of similarity to at least one other image frame of the respective subset, to generate a dataset for updating a neural network-based machine learning model using the dataset.

In some implementations, the method includes updating the neural network-based machine learning model using the dataset and not using any image frame removed from the plurality of clusters. In some implementations, the method includes adding a new image frame to a given cluster of the plurality of clusters responsive to the new image frame satisfying one or more difference thresholds with respect to the given cluster.

In some implementations, the method includes receiving the plurality of image frames from one or more cameras of a vehicle. In some implementations, the threshold amount of similarity corresponds to a target amount of size reduction of the dataset relative to the plurality of image frames.

Any one or more processors, systems, and/or methods described herein can be implemented using any of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more large language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs) —which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### BRIEF DESCRIPTION OF THE DRAWINGS

The present systems and methods for AI model-driven multimodal semantic data selection and/or enrichment are described in detail below with reference to the attached drawing figures, wherein:

FIG. 1 is a block diagram of an example system to perform AI model-driven multimodal semantic data selection and enrichment according to one or more implementations of the present disclosure;

FIG. 2 is a schematic diagram of an example process of AI model-driven semantic data selection and enrichment according to one or more implementations of the present disclosure;

FIG. 3 is a flow diagram of an example method of semantic data processing according to one or more implementations of the present disclosure;

FIG. 4A is a block diagram of an example generative language model system suitable for use in implementing at least some implementations of the present disclosure;

FIG. 4B is a block diagram of an example generative language model that includes a transformer encoder-decoder suitable for use in implementing at least some implementations of the present disclosure;

FIG. 4C is a block diagram of an example generative language model that includes a decoder-only transformer architecture suitable for use in implementing at least some implementations of the present disclosure;

FIG. 5 is a block diagram of an example computing device suitable for use in implementing at least some implementations of the present disclosure; and

FIG. 6 is a block diagram of an example data center suitable for use in implementing at least some implementations of the present disclosure.

### DETAILED DESCRIPTION

Systems and methods are disclosed related to updating/training machine learning and/or artificial intelligence (AI) models, such as AI model-driven multimodal semantic data selection and enrichment.

Some systems can train models, such as large language models, visual language models, and/or object detection or other computer vision models, based on targeting high-quality datasets, e.g., having an object-balanced distribution. However, various such approaches can require significant amounts of manual labeling, or are limited in scalability to addressing new types of information not previously represented in datasets.

Systems and methods in accordance with the present disclosure can generate more effective datasets that achieve target performance criteria (e.g., accuracy of the trained foundation models) with reduced size (e.g., due to the datasets having improved semantic diversity. This can allow for target performance, greater scalability, reduced data storage requirements (e.g., in datacenters) and/or training compute requirements to update/train foundation models using the datasets. For example, the system can generate clusters of data points (e.g., image frames from video, such as video of driving environments) according to semantic characteristics of the data points, and can excise data points from clusters that are not visually diverse, e.g., by greedy pruning.

For example, the system can generate, using one or more neural networks, (i) a semantic embedding of at least one (e.g., each) image frame of the plurality of image frames and (ii) a visual embedding of each of the at least one image frame of the plurality of image frames. The system can generate a plurality of clusters of the plurality of image frames according to the semantic embedding of each of the at least one image frame of the plurality of frames. The system can remove, from at least one (e.g., each) cluster of the plurality of clusters, at least one image frame according to the visual embedding of the at least one image frame and at least one other image frame of the cluster to provide a dataset comprising the plurality of image frames remaining from the plurality of clusters.

In some implementations, the one or more neural networks can include a multimodal language model (MLMM) to generate a description of at least one image frame. The one or more neural networks can include a transformer to generate the semantic embedding of each of the at least one image frame according to the description of each of the respective at least one image frame. The one or more neural networks can include a vision encoder configured to generate the visual embedding according to each image frame.

The system can perform pruning based on determining similarity, e.g., cosine similarity, amongst data points of clusters in order to remove data points that are visually similar. This can allow the system to update/train foundational models on more concise datasets while achieving target and/or higher performance, e.g., including as new data points are identified and selectively added according to semantic diversity.

In some implementations, the system can be implemented to allow for online dataset generation and/or model updating. For example, the system can be at least partially implemented in a vehicle and/or autonomous system, e.g., robot system, that can receive candidate new data for the dataset via one or more sensors, and can selectively update the dataset and/or update online models (e.g., online foundation and/or computer vision models) according to datapoints having semantic diversity relative to the dataset.

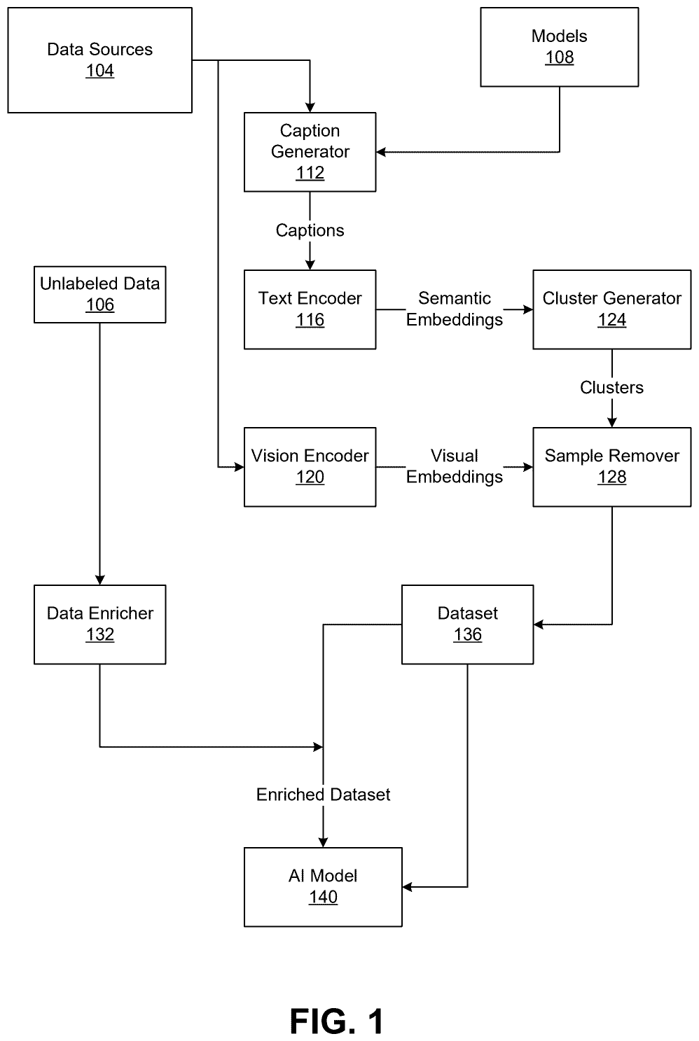

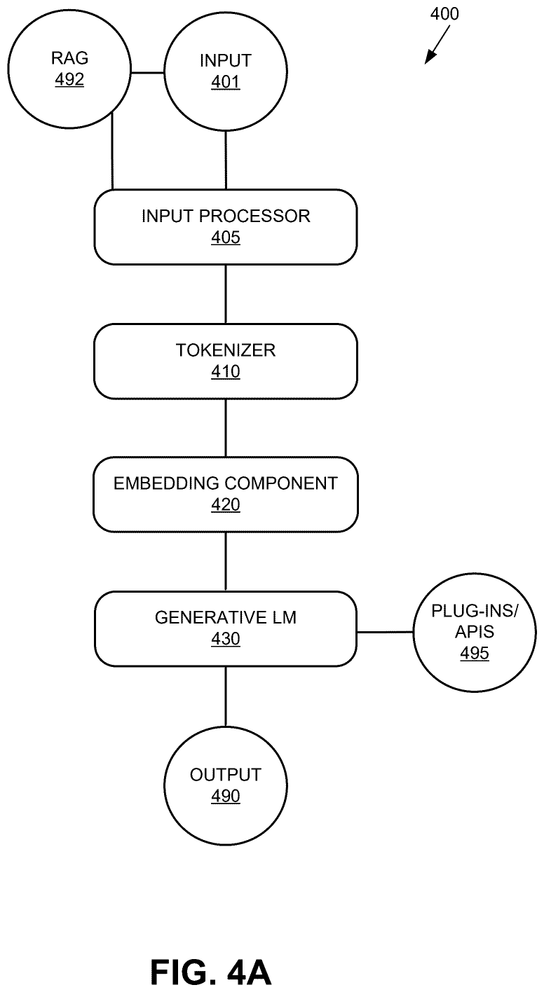

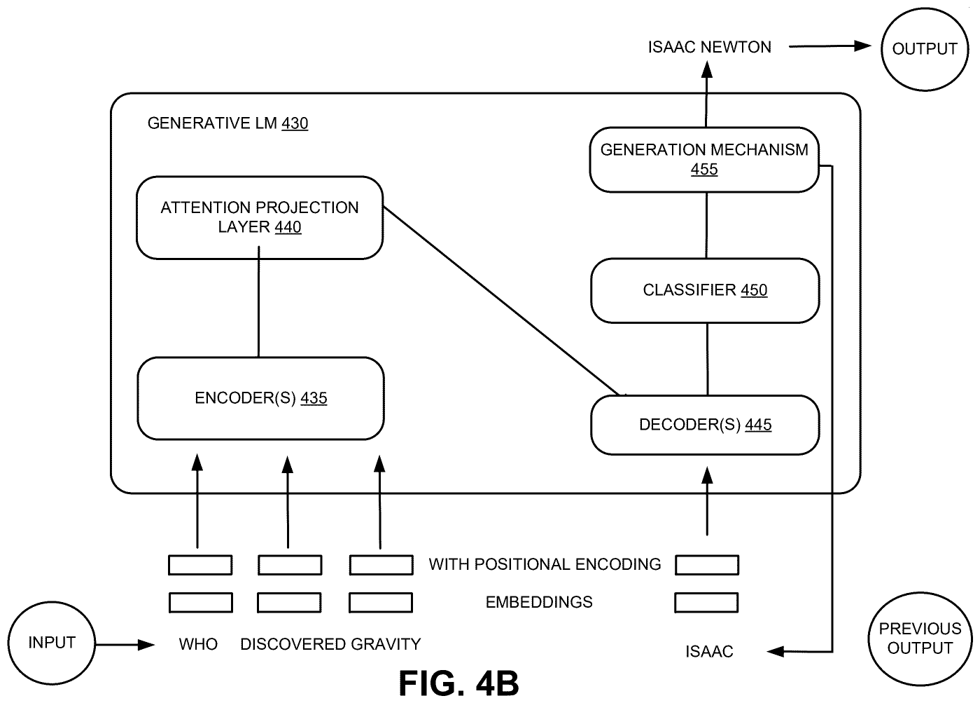

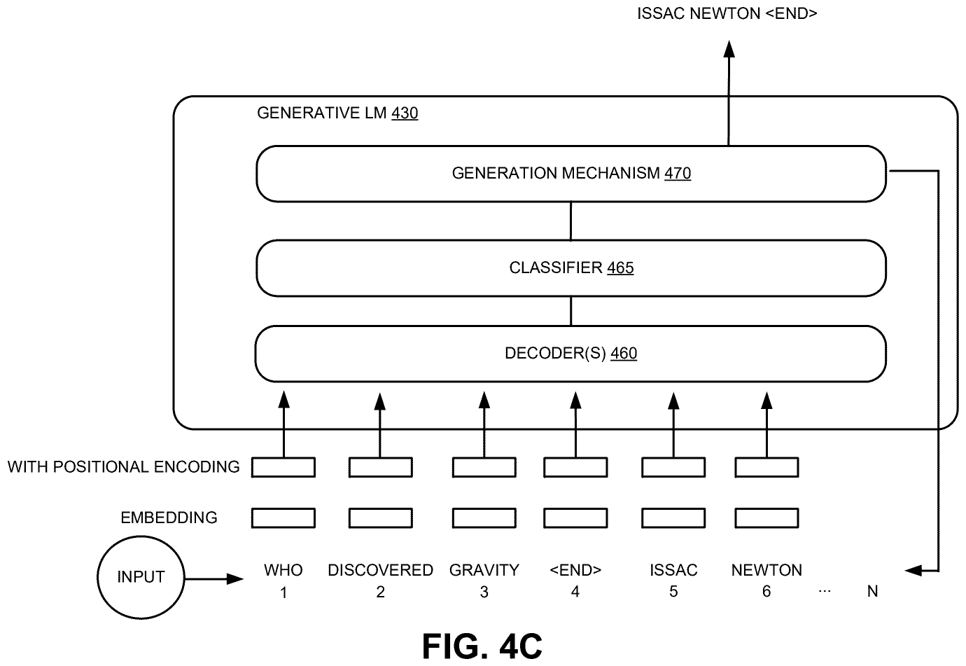

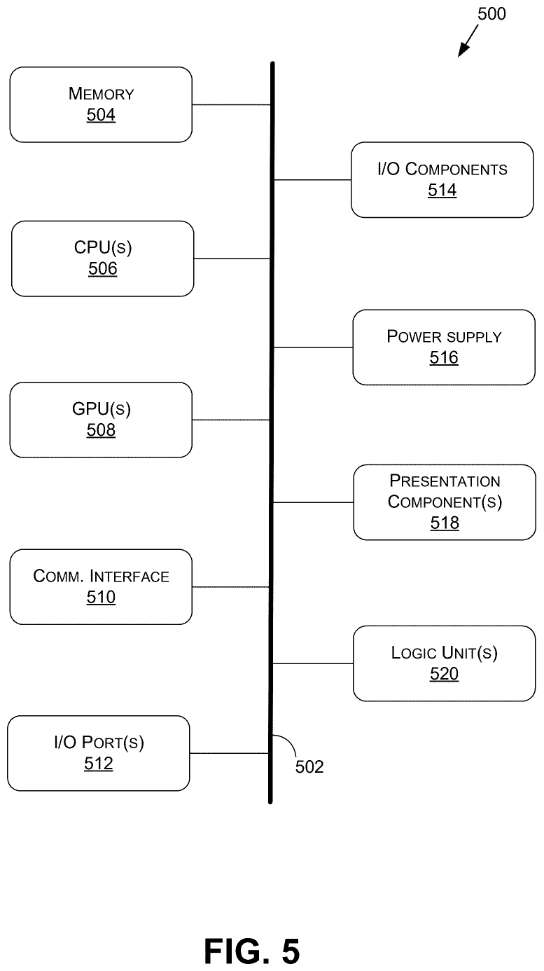

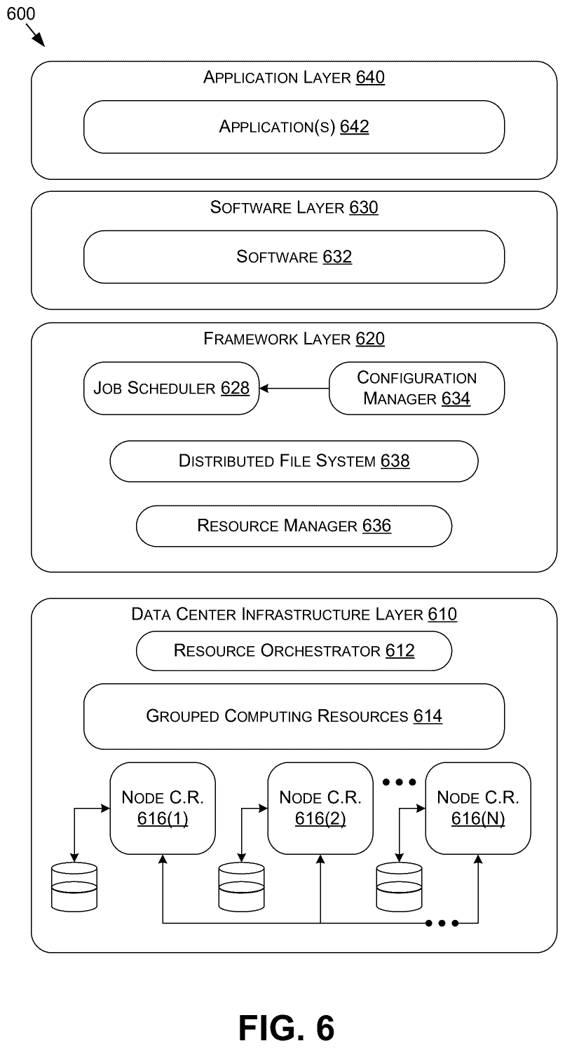

With reference to FIG. 1, FIG. 1 is an example of a system 100 to perform AI model-driven multimodal data selection and/or enrichment, in accordance with some implementations of the present disclosure. For example, the system 100 can retrieve a dataset, such as a dataset of images, can remove images from the dataset while retaining a target performance of an AI model to be updated/trained based on the (remaining) images of the dataset, and can selectively add new images to the dataset to enrich the dataset, such as to add new images that are semantically unique or distinct relative to the remaining images of the dataset, which can allow for improved performance of the AI model while avoiding significant increases in compute resources for storing the dataset and/or performing the updating/training. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some implementations, the system and methods described herein may be implemented using one or more generative language models (e.g., as described in FIGS. 4A-4C), one or more computing devices or components thereof (e.g., as described in FIG. 5), and/or one or more data centers or components thereof (e.g., as described in FIG. 6).

The system 100 can include or be coupled with at least one data source 104. The data source 104 can include, without limitation, data, e.g., data samples, such as any one or more of text, speech, audio, image, and/or video data. Images (including video) of the data can correspond to one or more views of a scene captured by an image capture device (e.g., camera), or images generated computationally, such as simulated or virtual images or video (including by being modifications of images from an image capture device). The images can each include a plurality of pixels, such as pixels arranged in rows and columns. The images can include image data assigned to one or more pixels of the images, such as color, brightness, contrast, intensity, depth (e.g., for three-dimensional (3D) images), or various combinations thereof. The data can include videos and/or video data structured as a plurality of frames (e.g., image frames, video frames), such as in a sequence of frames, where each frame is assigned a time index (e.g., time step, time point) and has image data assigned to one or more pixels of the images.

In some implementations, the data source 104 includes data that is labeled, e.g., assigned one or more labels. For example, any one or more data samples of the data source 104, such as images or image frames, can be assigned label(s) indicating one or more of a type, class, feature, identifier, or characteristic of the data sample or one or more objects or scenes represented by the data sample.

In some implementations, the data source 104 includes data from driving scenes. For example, the data source 104 can include images and/or image frames captured by cameras of vehicles. The image frames can represent any one or more objects in driving scenes such as pedestrians, vehicles, parking meters, sidewalks, buildings, signs, or combinations thereof. The image frames or portions thereof can be labeled with labels including, for example and without limitation, identifiers, classes, or bounding boxes corresponding to objects represented in the image frames.

In some implementations, the system 100 can retrieve unlabeled data 106. As described further herein, the system 100 can process unlabeled data 106 to enrich the dataset 136.

The system 100 can include one or more machine learning models 108. The machine learning models 108 can include artificial intelligence (AI) models or other models that can generate target outputs based on various types of inputs. The machine learning model 108 can include one or more neural networks. The neural network can include an input layer, an output layer, and/or one or more intermediate layers, such as hidden layers, which can each have respective nodes. The system 100 can train/update the neural network by modifying or updating one or more parameters, such as weights and/or biases, of various nodes of the neural network responsive to evaluating candidate outputs of the neural network.

The models 108 can be or include various neural network models, including models that are effective for operating on or generating data including but not limited to image data, video data, text data, speech data, audio data, or various combinations thereof. The machine learning models 108 can include one or more transformers, convolutional neural networks (CNNs), U-nets, vision transformers, recurrent neural networks (RNNs), long short-term memory (LSTM) models, other network types, or various combinations thereof. The machine learning models 108 can include generative models, such as generative adversarial networks (GANs), Markov decision processes, variational autoencoders (VAEs), Bayesian networks, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof. In some implementations, one or more models 108 can be pre-trained using, for example, image data, including but not limited to data from the data sources 104.

The model 108 can include one or more language models, such as a language model (e.g., large language model (LLM), small language model (SLM), vision language model (VLM), multi-modal language model (MMLM), etc.). For example, the model 108 can include one or more language models that are configured (e.g., trained, fine-tuned, updated, etc.) to receive image data and/or text data as input and generate text and/or images as output. The model 108, e.g., VLM and/or MMLM, can include one or more diffusion models and/or latent diffusion models, such as denoising network-based diffusion models that can operate on image-type data.

Referring further to FIG. 1, the system 100 can include at least one caption generator 112. The caption generator 112 can include one or more machine learning models 108 or components thereof. For example, the caption generator 112 can include at least one of a VLM or a MMLM to receive, as input, a data sample from data source 104 (e.g., an image frame) and generate, as output, a description of the data sample. The description can indicate features of any one or more objects represented in the data sample. The system 100 can provide to the caption generator 112 one or more prompts for requesting information to include in the description. The prompts can include, for example and without limitation, requests such as a general scene description, a general description of what is happening in the scene, important objects to consider while driving, or dynamic objects. For example, given an image frame representing a scene of a road and a crosswalk, the system 100 can prompt the caption generator 112 to generate a description of a location of the crosswalk (e.g., relative to a position from which the image frame is captured), any pedestrians in the crosswalk, and any vehicles on the road. This can allow the caption generator 112 to generate long, dense captions from the data of the data source 104. For example, the caption generator 112 can generate a caption such as “The road is a two-lane highway with a clear dividing line. The weather appears to be overcast, with a gray sky suggesting it might be cloudy or possibly early morning or late afternoon. There are no other vehicles visible in the immediate vicinity of the ego vehicle, indicating a moment of clear driving with no immediate traffic. The road itself appears to be in good condition, with no visible debris or obstructions. The overall driving condition seems calm and uneventful at the moment.”

The system 100 can include at least one text encoder 116. The text encoder 116 can receive the description (e.g., in a text and/or natural language format) of the image frame generated by the caption generator 112, and can encode the description to generate an embedding, e.g., a semantic embedding, of the description. This can allow for more efficient comparison of the image frames based on the descriptions of the image frames. For example, the text encoder 116 can include a transformer model, such as a transformer encoder, such as a sentence transformer. The text encoder 116 can encode the description into a text embedding space, such as to generate the embedding to capture high-order semantics for the scene represented by the image frame. For example, the text encoder 116 can encode the description to generate the embedding as text and/or natural language. For example, following from the example description above, the text encoder 116 can generate the embedding as “highway overcast, no other vehicles visible in the immediate vicinity, no visible debris or obstructions, calm and uneventful.”

Referring further to FIG. 1, the system 100 can include at least one vision encoder 120. The vision encoder 120 can generate a visual embedding of any one or more data samples, e.g., image frames, of the data source 104, such as the image frames for which semantic embeddings are generated. The vision encoder 120 can include any one or more models 108 that are configured (e.g., trained, fine-tuned, updated, etc.) to generate embeddings in a visual space of image data. For example, the vision encoder 120 can include a contrastive language-image pre-training (CLIP) model. The vision encoder 120 can generate the visual embedding according to the image frame.

Referring further to FIG. 1, the system 100 can include at least one cluster generator 124. The cluster generator 124 can cluster the image frames according to the semantic embeddings of the image frames determined by the text encoder 116. For example, the cluster generator 124 can generate a plurality of clusters and assign at least one (e.g., each) image frame to a given cluster of the plurality of clusters according to the semantic embedding of the image frame. In some implementations, the clusters represent subsets of image frames assigned to corresponding clusters. For example, the cluster generator 124 can assign one or more image frames to at least one (e.g., each) cluster, such as based at least on similarity and/or distance amongst the semantic embeddings of the image frames. The cluster generator 124 can perform any of various clustering operations to assign the image frames to clusters, including, for example and without limitation, K-means clustering.

Referring further to FIG. 1, the system 100 can include at least one sample remover 128. The sample remover 128 can remove data samples, e.g., image frames, from one or more of the clusters generated by the cluster generator 124, and can output a dataset 136 that includes the data samples retained (e.g., not removed) responsive to performing the removal. This can allow the sample remover 128 to reduce the dataset 136 in size (e.g., storage requirements and/or number of data samples) relative to the amount of data of the clusters as outputted by the cluster generator 124, for example. Operation of the sample remover 128 can result in removing semantically and/or visually redundant data samples from the data samples of the clusters.

For example, the sample remover 128 can perform the removal to retain semantically unique data samples while removing visually similar or redundant data samples. This can allow for the size of the dataset 136 to be reduced while retaining or improving performance of image processing model 140. For example, the sample remover 128 can remove visually similar scenes within the semantic clusters based at least on the visual embeddings of the data samples.

In some implementations, the sample remover 128 removes, from a given cluster, at least one data sample (e.g., a first data sample) according to the visual embedding of the data sample and the visual embedding of at least one other data sample (e.g., a second data sample) of the given cluster. The sample remover 128 can remove the first data sample based at least on a comparison of the visual embedding of the data sample and the visual embedding of the second data sample. For example, the sample remover 128 can determine a similarity, such as a cosine similarity, between the visual embeddings of the first and second data samples, and can remove the first data sample responsive to the cosine similarity exceeding a threshold (e.g., 1 minus cosine (visual embeddings of the data samples) is less than the threshold). For example, for a given data sample of the given cluster, if the cosine similarity determination indicates that the threshold is exceeded with respect to any other data sample of the given cluster, the sample remover 128 can remove the given data sample. In some implementations, the sample remover 128 iteratively determines similarities amongst visual embeddings of multiple and/or all pairs of data samples of the given cluster to identify the data samples to remove. The sample remover 128 can perform greedy removal of data samples for which similarity of visual embeddings relative to visual embeddings of other data samples exceeds the threshold. The sample remover 128 can perform removal operations for any and/or all of the clusters. By performing any of various such pruning operations, the sample remover 128 can reduce the number of data samples assigned to each cluster to generate the dataset 136.

Referring further to FIG. 1, the system 100 can include at least one data enricher 132. The data enricher 132 can determine whether to add any one or more data samples to the dataset 136, e.g., to add data samples from unlabeled data 106, or from any of various data sources (e.g., other than data previously used to determine the clusters). The system 100 can determine to add an additional data sample based at least on one or more of a target number of additional data samples and a threshold amount of difference between the semantic embedding of the additional data sample and the semantic embedding(s) of one or more data samples of the clusters. For example, for a given candidate data sample for addition to the dataset 136, the system 100 can identify semantic anchors of each cluster, such as a centroid of each cluster, can determine the cosine similarity between the semantic embedding of the candidate data sample and the semantic embedding of the centroid, and can determine to add the candidate data sample to the dataset 136 based at least on the cosine similarity and a target amount of data samples to be added to the dataset 136. In some implementations, the target amount is a predefined number of data samples. In some implementations, the target amount corresponds to a performance score of AI model 140 resulting from updating of the AI model 140 according to the data of the dataset 136; for example, this can allow for an end-to-end training of the AI model 140 such that candidate data samples are selectively included in the dataset 136 based on how the performance of the AI model 140 is improved and/or optimized.

In some implementations, the system 100 can generate efficient datasets 136 without relying on a predetermined dataset, such as initially curated or labeled data of data sources 104. For example, for each of one or more candidate data samples for which to generate the dataset 136, the system 100 can generate a caption for the candidate data sample (e.g., using the caption generator 112), can generate a semantic embedding of the caption (e.g., using the text encoder 116), can generate a visual embedding of the candidate data sample (e.g., using the vision encoder 120) and can determine to assign the candidate data sample to an existing cluster or generate a new cluster (e.g., using the cluster generator 120) based at least on the semantic embedding of the candidate data sample, the visual embedding of the candidate data sample, and the visual embedding of one or more data samples that have been assigned to existing clusters; or the system 100 can determine to skip assignment of the candidate data sample to any clusters responsive to the visual embedding indicating that the candidate data sample is not sufficiently distinct from data samples of the clusters.

In some implementations, the system 100 includes or is coupled with at least one AI model 140. The AI model 140 can include one or more machine learning models 108 or components thereof. The AI model 140 can include one or more AI models to be used any one or more of object detection, object classification, object tracking, or autonomous vehicle operations, for example and without limitation.

The AI model 140 can have a performance score with respect to one or more tasks. The performance score can represent, for example and without limitation, accuracy, precision, and/or recall of the AI model 140 with respect to performing the task. As an example, the AI model 140 can be scored according to its accuracy in classifying objects or assigning bounding boxes to objects in images. By updating the AI model 140 using the (efficient) dataset 136, the AI model 140 can be updated with fewer computational resources and while meeting or exceeding prior performance.

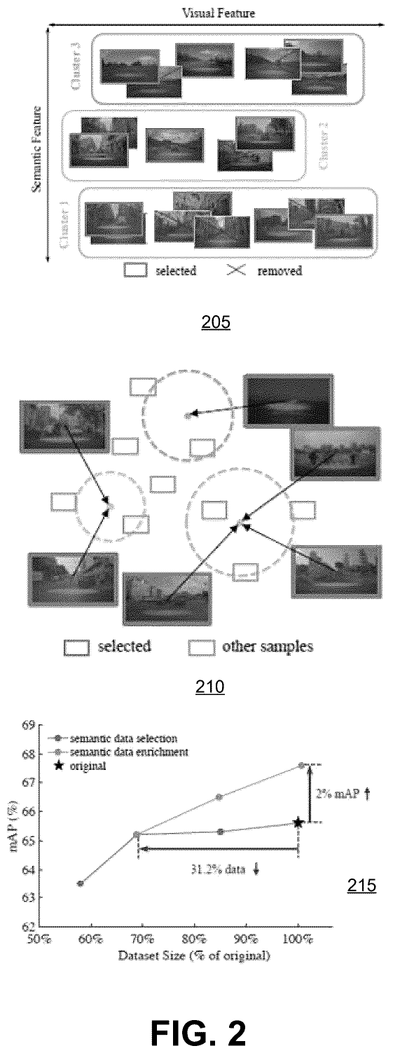

FIG. 2 depicts an example of a process 200 of performing semantic data selection and/or enrichment. The process 200 can be performed, for example, using one or more components of the system 100.

At 205, data samples, such as image frames, can be retrieved as clusters, where the image frames are clustered according to semantic features of the data samples. For example, each cluster can have a subset of the image frames that are semantically similar, such as to represent similar objects, scenes, and/or actions. From any given cluster, data samples can be removed that are visually similar to one or more other data samples of the given cluster. For example, a first image frame can be removed from a first cluster responsive to a cosine similarity of the first image frame and a second image frame of the first cluster being greater than a threshold similarity. The similarities of image frames can be iteratively evaluated to allow for removal of image frames from the clusters until a termination condition, such as a target number and/or size of remaining image frames and/or until no further image frames meet the conditions for removal from their respective thresholds. This can result in a dataset that

At 210, other samples, e.g., new image frames, can be selectively added to the dataset to enrich the dataset. For example, for a given (new) image frame, a semantic embedding can be determined in order to identify a (closest) candidate cluster to which the given image frame may potentially be assigned, and a visual embedding of the given image frame can be compared (e.g., using cosine similarity) to visual embeddings of image frames in the candidate cluster to determine whether the given image frame is sufficiently distinct to be selected for inclusion in the cluster.

Chart 215 depicts performance of an AI model configured according to the process 200. As depicted in FIG. 2, the data removal (e.g., operation(s) 205) can be used to remove 31.2 percent of data from an original dataset, with a relatively minimal change in performance of the AI model as measured with mean average precision (mAP). The data enrichment (e.g., operation(s) 210) can be used to add about the same amount of data to the dataset while achieving a much greater increase in performance than the change in performance from the data removal.

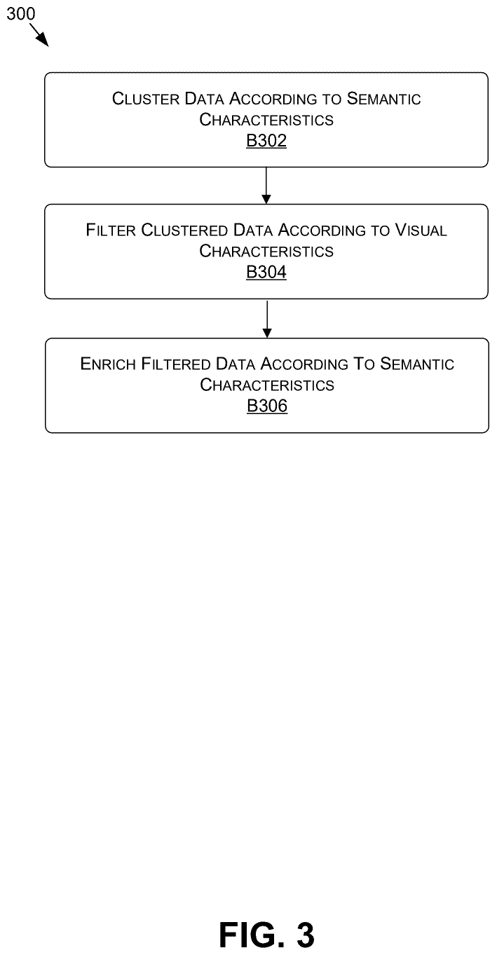

Now referring to FIG. 3, each block of method 300, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 300 is described, by way of example, with respect to the system of FIG. 1. However, this method may additionally or alternatively be executed by any one system, or any combination of systems, including, but not limited to, those described herein. Various operations of the method 300 can be performed in batch and/or sequential operations, including but not limited to in response to receiving image data streamed from any one or more sensors and/or cameras.

FIG. 3 is a flow diagram showing a method 300 for AI model-based data selection and enrichment, in accordance with some implementations of the present disclosure. The method 300, at block B302, includes clustering data according to semantic characteristics of the data. For example, k-means clustering can be performed on a plurality of image frames according to semantic characteristics (e.g., embeddings) of the image frames to generate clusters of image frames.

At block B304, the clustered data can be filtered according to visual characteristics of the image frames. For example, visual embeddings of one or more image frames can be used to identify visually similar image frames in any one or more clusters; visually similar image frames can be removed until a removal condition (e.g., number of removals; size of remaining dataset; no image frames meeting a similarity threshold) is satisfied.

At block B306, the filtered data can be enriched using new image frames. For example, semantic embeddings of the new image frames(s) can be evaluated to identify candidate clusters to which the new image frames can be assigned. For example, new image frame(s) that have semantic embedding(s) that are at least a threshold distance away from the semantic embeddings of the filtered data can be added to the dataset. In some implementations, the filtered data and/or the enriched data can be used to configure (e.g., train, fine-tune, update) an AI model.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications. For example, systems and methods in accordance with the present disclosure can be used to reduce the size of AI model training sets stored in any of various systems, including but not limited to data centers; to update foundation models as well as other models that operate on sensor and/or camera data, such as to facilitate vehicle AI models; to increase the performance of any of various VLMs and/or MMLMs; or various combinations thereof.

Disclosed implementations may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in implementations, based on the models being trained on massive datasets and having architectures with large number of learnable network parameters (weights and biases) —such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in implementations, whereas in other implementations, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types. This can include, for example and without limitations, performing operations described herein such as generating captions or question/answer annotations regarding images or video.

Various types of LLMs/SLMs/VLMs/MMLMs/etc. architectures may be implemented in various implementations. For example, different architectures may be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) may be used, while in other implementations transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular implementation and the task(s) being performed using the LLMs/SLMs/VLMs/MMLMs/etc.

In various implementations, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure may be implemented using various model alignment techniques. For example, in some implementations, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application.

In some implementations, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data may be provided with the same input query and prompt (e.g., set of constraints, conditioners, etc.). In one or more implementations, the language models may be different versions of the same foundation model. In one or more implementations, at least one language model may be instantiated as multiple agents—e.g., more than one prompt may be provided to constrain, direct, or otherwise influence a style, a content, or a character, etc., of the output provided. In one or more example, non-limiting implementations, the same language model may be asked to provide output corresponding to a different role, perspective, character, or having a different base of knowledge, etc. —as defined by a supplied prompt.

In any one of such implementations, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more implementations, the output from one language model—or version, instance, or agent—maybe be provided as input to another language model for further processing and/or validation. In one or more implementations, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more implementations, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some implementations of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLMs/SLMs/VLMs/MMLMs/etc.). In some implementations, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some s in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some implementations, a RAG component 492 (which may include one or more RAG models, and/or may be performed using the generative LM 430 itself) may be used to retrieve additional information to be used as part of the input 401 or prompt. RAG may be used to enhance the input to the LLMs/SLMs/VLMs/MMLMs/etc. with external knowledge, so that answers to specific questions or queries or requests are more relevant—such as in a case where specific knowledge is required. The RAG component 492 may fetch this additional information (e.g., grounding information, such as grounding text/image/video/audio/USD/CAD/etc.) from one or more external sources, which can then be fed to the LLMs/SLMs/VLMs/MMLMs/etc. along with the prompt to improve accuracy of the responses or outputs of the model.

For example, in some implementations, the input 401 may be generated using the query or input to the model (e.g., a question, a request, etc.) in addition to data retrieved using the RAG component 492. In some implementations, the input processor 405 may analyze the input 401 and communicate with the RAG component 492 (or the RAG component 492 may be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some implementations, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLMs/SLMs/VLMs/MMLMs/etc. Rather than (or in addition to) providing the model with chunks of data extracted from larger sized documents—which may result in a lack of context, factual correctness, language accuracy, etc. —graph RAG may also provide structured entity information to the LLMs/SLMs/VLMs/MMLMs/etc. by combining the structured entity textual description with its many properties and relationships, allowing for deeper insights by the model. When implementing graph RAG, the systems and methods described herein use a graph as a content store and extract relevant chunks of documents and ask the LLMs/SLMs/VLMs/MMLMs/etc. to answer using them. The knowledge graph, in such implementations, may contain relevant textual content and metadata about the knowledge graph as well as be integrated with a vector database. In some implementations, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLMs/SLMs/VLMs/MMLMs/etc. may summarize the results. In such an example, the graph may store relevant factual information, and a query (natural language query) to graph query tool (NL-to-Graph-query tool) and entity linking may be used. In some implementations, graph RAG (e.g., using a graph database) may be combined with standard (e.g., vector database) RAG, and/or other RAG types, to benefit from multiple approaches.

In any implementations, the RAG component 492 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the . Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular implementation.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some s in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some s in which the input 401 includes audio data, the input processor 401 may resample an audio file to a consistent sampling rate for uniform processing, and the embedding component 420 may use any known technique to extract and encode audio features—such as in the form of a spectrogram (e.g., a mel-spectrogram). In some s in which the input 401 includes video data, the input processor 401 may extract frames or apply resizing to extracted frames, and the embedding component 420 may extract features such as optical flow embeddings or video embeddings and/or may encode temporal information or sequences of frames. In some s in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the . For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some implementations, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 5 is a block diagram of an example computing device(s) 500 suitable for use in implementing some implementations of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In implementations, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In implementations, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) —which may include one or more direct memory access (DMA) systems, one or more vision or vector processing units (VPUs), one or more pixel processing engines (PPEs) —e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one implementations of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one implementation, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) may correspond to a server having one or more of the above-mentioned computing resources. In addition, in some implementations, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one implementation, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one implementation, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one implementation, resource orchestrator 612 may include a software design infrastructure (SDI) management entity for the data center 600. The resource orchestrator 612 may include hardware, software, or some combination thereof.

In at least one implementation, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one implementation, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one implementation, clustered or grouped computing resources may include grouped computing resource 614 at data center infrastructure layer 610. The resource manager 636 may coordinate with resource orchestrator 612 to manage these mapped or allocated computing resources.

In at least one implementation, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one implementation, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 600. In at least one implementation, trained or deployed machine learning models corresponding to one or more neural networks may be used to infer or predict information using resources described above with respect to the data center 600 by using weight parameters calculated through one or more training techniques, such as but not limited to those described herein.

In at least one implementation, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate, using one or more neural networks, (i) a semantic embedding of one or more image frames of a plurality of image frames and (ii) a visual embedding of each of the one or more image frames of the plurality of image frames;
generate a plurality of clusters of the plurality of image frames according to the semantic embedding of each of the one or more image frames of the plurality of image frames; and
remove, from at least one cluster of the plurality of clusters, at least one image frame according to the visual embedding of the at least one image frame and at least one other image frame of the at least one cluster to provide a dataset comprising the plurality of image frames remaining from the plurality of clusters.

2. The one or more processors of claim 1, wherein:
the plurality of image frames are a plurality of first image frames; and
the processing circuitry is to:
cause the one or more neural networks to generate a semantic embedding of at least one second image frame;
identify a given cluster of the plurality of clusters corresponding to the semantic embedding; and
add the at least one second image frame to the dataset responsive to the semantic embedding of the at least one second image frame satisfying one or more difference thresholds with respect to the given cluster.

3. The one or more processors of claim 1, wherein the one or more neural networks comprise:
a multimodal language model (MLMM) to generate a description of each image frame;
a transformer to generate the semantic embedding of each of the one or more image frames according to the description of each of the one or more image frames; and
a vision encoder configured to generate the visual embedding according to each of the one or more image frames.

4. The one or more processors of claim 1, wherein the plurality of image frames comprise one or more images of a driving environment.

5. The one or more processors of claim 1, wherein the processing circuitry is to evaluate a performance of an objection detection model that is updated according to the dataset relative to being trained according to the plurality of image frames.

6. The one or more processors of claim 1, wherein the processing circuitry is to remove the at least one image frame based at least on a similarity score between the visual embedding of the at least one image frame and the visual embedding of the at least one other image frame.

7. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

8. A system comprising one or more processors to:
generate, using one or more neural networks, (i) a semantic embedding of one or more image frames of a plurality of image frames and (ii) a visual embedding of each of the one or more image frames of the plurality of image frames;
generate a plurality of clusters of the plurality of image frames according to the semantic embedding of each of the one or more image frames of the plurality of image frames; and
remove, from at least one cluster of the plurality of clusters, at least one image frame according to the visual embedding of the at least one image frame and at least one other image frame of the at least one cluster to provide a dataset comprising the plurality of image frames remaining from the plurality of clusters.

9. The system of claim 8, wherein:
the plurality of image frames are a plurality of first image frames; and
the one or more processors are to:
cause the one or more neural networks to generate a semantic embedding of at least one second image frame; and
add the at least one second image frame to the dataset responsive to the semantic embedding of the at least one second image frame satisfying one or more difference thresholds with respect to the semantic embedding of one or more first image frames of the plurality of first image frames.

10. The system of claim 8, wherein the one or more neural networks comprise:
a multimodal language model (MLMM) to generate a description of each of the one or more image frames;
a transformer to generate the semantic embedding of each of the one or more image frames according to the description of each of the one or more image frames; and
a vision encoder configured to generate the visual embedding according to each image frame.

11. The system of claim 8, wherein the plurality of image frames comprise one or more images of a driving environment.

12. The system of claim 8, wherein the one or more processors are to evaluate a performance of an objection detection model that is trained according to the dataset relative to being trained according to the plurality of image frames.

13. The one or more processors of claim 8, wherein the one or more processors are to remove the at least one image frame based at least on a similarity score between the visual embedding of the at least one image frame and the visual embedding of the at least one other image frame.

14. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

15. A method comprising:
generating, based at least on a semantic characteristic of one or more image frames of a plurality of image frames, a plurality of clusters to which a respective subset of the plurality of image frames is assigned; and
filtering the respective subset of at least one cluster of the plurality of clusters by removing at least one image frame of the respective subset based at least on a visual characteristic of the at least one image frame that indicates that the at least one image frame has a threshold amount of similarity to at least one other image frame of the respective subset, to generate a dataset for updating a neural network-based machine learning model using the dataset.

16. The method of claim 15, further comprising updating the neural network-based machine learning model using the dataset and not using any image frame removed from the plurality of clusters.

17. The method of claim 15, further comprising adding a new image frame to a given cluster of the plurality of clusters responsive to the new image frame satisfying one or more difference thresholds with respect to the given cluster.

18. The method of claim 15, further comprising receiving the plurality of image frames from one or more cameras of a vehicle.

19. The method of claim 15, wherein the threshold amount of similarity corresponds to a target amount of size reduction of the dataset relative to the plurality of image frames.

20. The method of claim 15, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more large language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.
